(19) United States
(12) Patent Application Publication
(10) Pub. No.: US 2014/0324994 A1
(43) Pub. Date: Oct. 30, 2014

(54) METHOD AND DEVICE FOR TRANSMITTING AND FORWARDING A MESSAGE

(71) Applicant: Xiao Sun, Shenzhen (CN)

(72) Inventor: Xiao Sun, Shenzhen (CN)

(21) Appl. No.: 13/994,082

(22) PCT Filed: Apr. 28, 2013
(86) PCT No.: PCT/CN13/74998

§ 371 Date: Jun. 13, 2013

(51) Int. Cl. H04L 12/58

(52) U.S. Cl. CPC H04L 51/04
USPC 709/206

(57) ABSTRACT

In a method for transmitting a message, a first client device sends a message to a server, wherein the message includes a tag; the server forwards the message to at least one second client device; each of the at least one second client device receives the message from the server; and each of the at least one second client device outputs a new message notification in a predetermined format. A system and client devices for transmitting and forwarding a message are also provided.

### FIELD

The present disclosure relates to a method and a device for transmitting a message. The present disclosure also relates to a method and a device for forwarding a message.

### BACKGROUND

Instant Messaging (IM) is a form of communication over the Internet that offers quick transmission of messages from sender to receiver. It may address point-to-point communications as well as multicast communications called group chat from one sender to many receivers.

At present, some instant messaging service providers provide the platform for group chat. For example, using WeChat (Weixin) or QQ client, a user can set up a group and chat with all the members of the group simultaneously.

### SUMMARY

Various examples of the present disclosure provide a method and a device for transmitting a message.

According to one example of the present disclosure, a computer-implemented method for transmitting a message is presented.

The method includes: sending, by a first client device, a message to a server, wherein the message includes a tag; forwarding, by the server, the message to at least one second client device; receiving, by each of the at least one second client device, the message from the server; and outputting, by each of the at least one second client device, a new message notification in a predetermined format.

According to another example of the present disclosure, a computer-implemented method for transmitting a message is presented.

The method includes: receiving a message from a server; determining whether the message includes a tag; and outputting a new message notification in a predetermined format when the message includes the tag.

According to still another example of the present disclosure, a client device for transmitting a message is presented.

The client device includes: memory; at least one processor; and at least one program stored in the memory and configured for execution by the at least one processor, the one or more programs including instructions to: receive a message from a server; determine whether the message includes a tag; and output a new message notification in a predetermined format when the message includes the tag.

According to still another example of the present disclosure, a computer-implemented method for forwarding a message is presented.

The method includes: receiving a message; determining whether the message includes a tag and a user ID; and forwarding the message to a client device corresponding to the user ID and forcing the client device to output a new message notification in a predetermined format when the message includes the tag and the user ID.

The methods and devices provided by various examples of the present disclosure beneficially allows the user always be notified of a new message when the received message includes the tag, no matter what setting of the client is.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network computer system 100 for transmitting a message in accordance with an example of the present disclosure.

FIG. 2 is a block diagram illustrating a method for transmitting a message in accordance with an example of the present disclosure.

FIG. 3 is a block diagram illustrating a method for transmitting a message in accordance with another example of the present disclosure.

FIG. 4 is a block diagram illustrating a method for transmitting a message in accordance with still another example of the present disclosure.

FIG. 5 is a schematic diagram illustrating a smartphone 110 for transmitting a message in accordance with an example of the present disclosure.

FIG. 6 is a block diagram illustrating a method for forwarding a message in accordance with still another example of the present disclosure.

FIG. 7 is a schematic diagram illustrating a server 160 for forwarding a message in accordance with an example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. In addition, the terms “a” and “an” are intended to denote at least one of a particular element.

Aspects of the present disclosure are described herein with reference to flowchart illustrations and/or block diagrams of method, device (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks.

These computer program instructions may also be stored in a computer readable medium that can direct a computer, other programmable data processing device, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing device, or other devices to cause a series of operational steps to be performed on the computer, other programmable processing device or other devices to produce a computer implemented process such that the instructions which execute on the computer or other programmable device provided processes for implementing the functions/acts specified in the flowchart and/or block diagram block or blocks.

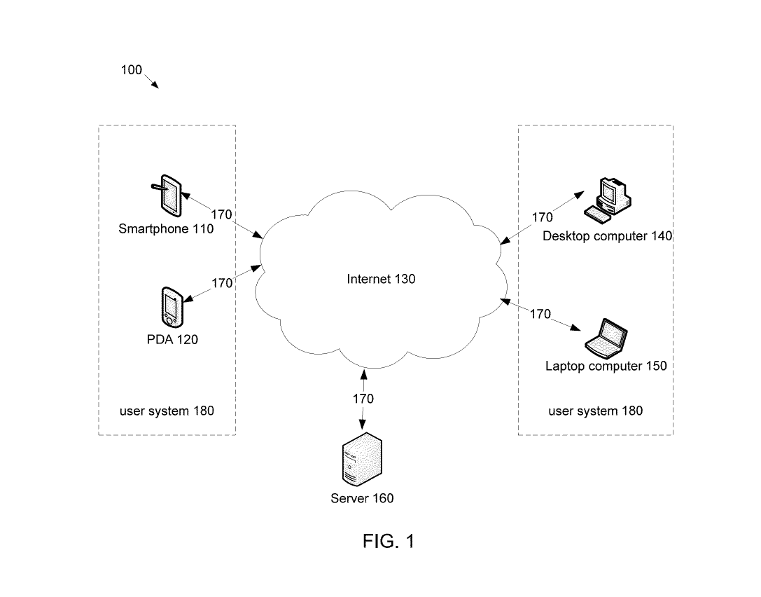

Referring now to FIG. 1, a network computer system 100 for transmitting a message in accordance with an example of the present disclosure comprises: a server 160; a user system 180; and a network, such as Internet 130. The user system 180 may include one or more client devices such as a smartphone 110, a Personal Digital Assistant 120, a desktop computer 140 and a laptop computer 150. Additionally, other devices such as netbooks, handheld and palmtop devices are also included in the description of client devices that may be deployed as a client device in user system 180.

All of the client devices in the user system 180 are connected or coupled via a link 170 to the Internet 130.

Smartphone 110, PDA 120, desktop computer 140 and laptop computer 150 include communication software to enable users to access the server 160. Typically, users of smartphone 110, PDA 120, desktop computer 140 and laptop computer 150 access the server 160 using an client application installed in the smartphone 110, PDA 120, desktop computer 140 and laptop computer 150.

The server 160 may support messaging services, i.e., allow users to send and receive messages.

To begin an messaging session, a user may access the server 160 using an client application and then exchanges messages with the particular buddies or participates in a group chat.

Link 170 represents any suitable communication link or similar communication mechanism including some combination of a hardwired connection, an internal or external bus, a connection for telephone access via radio, infrared or other wireless communication methodologies (i.e., “Wi-Fi” or “Wi-max”, “Bluetooth”, infrared, etc.), private or proprietary local area networks (LANs) and wide area networks (WANs), as well as standard computer network communications over Internet 130 or an internal network (e.g., “intranet”) via a wired or wireless connection, or any other suitable connection between computers and computer components known to those skilled in the art, whether currently known or developed in the future.

In addition to the other components shown in FIG. 1, a wireless communication access device may be communicatively coupled to link 170 and may be any wireless communication mechanism that is known to those skilled in the art to provide wireless communication between the Internet 130 and various devices associated with the Internet 130, including smartphone 110, PDA 120, desktop computer 140 as well as laptop computer 150. In various examples of the present disclosure, an acceptable wireless communication access device may comprise any type of wireless access point, wireless bridge, wireless router, or similar type of device (no shown in FIG. 1).

Server 160 in FIG. 1 represents a computer system that is made available to the client devices in the user system 180 via link 120 and the Internet 130. Various hardware components (not shown in FIG. 1) such as external monitors, keyboards, mice, tablets, hard disk drives, magnetic tapes, and other devices may be used in conjunction with server 160.

The server 160 may include a user profile server (not shown) connected to a database (not shown) for storing large amounts of user profile data. The user profile server may be used to enter, retrieve, edit, manipulate or otherwise process user profile data. In one implementation, a user's profile data includes, for example, user name, buddy list, geographic location, interests, etc. Users may enter, edit and/or delete profile data using the installed client application or through the public platform.

Server 160 may also provide various additional software components (not shown in FIG. 1) such as database servers, web servers, firewalls, security software, and the like. The use of these various hardware and software components is well known to those skilled in the art. In at least one preferred example, the server 160 is used to offer group chat and other IM services.

Smartphone 110 and PDA 120 in the user system 180 are representatives of any type of cellular device or telephone that may be communicatively coupled to network computer system 100.

Desktop computer 140 in the user system 180 may be any type of computer system known to those skilled in the art that is capable of being configured for use with network computer system 100 as described herein. As previously explained in conjunction with server 160, various hardware components and software components (not shown in FIG. 1) known to those skilled in the art may be used in conjunction with computer 140.

Similarly, laptop computer 150 in the user system 180 may be any type of portable computer system known to those skilled in the art that is capable of being configured for use with network computer system 100 as described herein.

Hereinafter, the method provided by various examples of the present disclosure will be described more fully with reference to the network computer system 100.

At present, when chatting with a buddy with an client application, such as WeChat (Weixin) or QQ, the client device which installs the client application may output a new message notification in a format (hereinafter called a first format) that a new message is received, for example, the client device may play a predefined sound (hereinafter called a first sound) and/or display a predefined icon (hereinafter called a first icon) or a predefined notice on the interface of the client and/or vibrate the client device. But sometimes frequent prompts may greatly disturb the user, especially when the user is busy. In this circumstance, the user can change the message notification configuration of the client application or the client device, for example, the user can switch the new message notification setting of the client device to an “off” status or the user can switch the new message notification setting of the client application to an “off” status. When the new message notification setting of the client application or client device is set to an “off” status, the client device will not output a notification to the user when receiving a new message. Thus the user can read the messages received at any time he/she wants. But another problem arises in this situation, that is, delayed responses. If someone has something urgent or important to talk with the user, the user may not notice the message, thus he/she will not receive the response from the user in time.

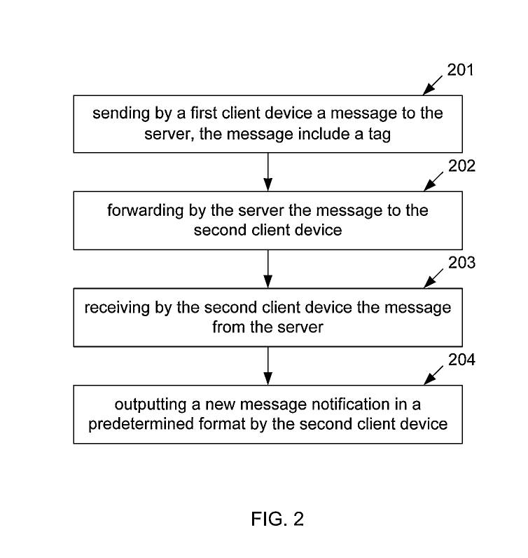

Referring now to FIG. 2, a block diagram of transmitting a message in a point-to-point communication in accordance with an example of the present disclosure is depicted. The message can be but not limited to an instant message. The procedure of FIG. 2 may be implemented by various types of hardware, software, device, computer, computer system, equipment, component, program, application, code, storage medium, or propagated signal.

The method shown in FIG. 2 involves sending by a first client device a message to the server 160, the message include a tag (block 201), forwarding by the server 160 the message to a second client device (block 202), receiving by the second client device the message from the server 160 (block 203) and outputting a new message notification in a predetermined format by the second client device (block 204).

In block 201, the message sent by the first client device may include a tag indicating that the message is of a higher priority than other messages, and the receiver of the message should be notified of the arrival of the message with the tag in a predetermined format.

The predetermined format may be the same with or different to the first format. For example, when the new message notification setting of the client application or client device is set to an “off” status, the second client device should output a new message notification in the first format. Or the predetermined format refers to a second format different from the first format, such as playing a second sound and/or displaying a second icon or a notice on the interface of the client and/or vibrating the client device.

The tag can be a self-defined character or a character string, such as &, * or #. In at least one preferred example, the tag can be @.

In block 202, the server 160 forwards the message received from the first client device to the second client device as a regular message without the tag.

In block 203, the second client device receives the message from the server 160.

In block 204, the second client device determines whether the message includes the tag by searching the content of the message for the tag, when the message includes the tag, it means that the message is of a higher priority and the second client device should output a new message notification in a predetermined format. As discussed above, the predetermined format may be or may not be the same with the first format. Thus in block 204, when new message notification setting of the client application or the client device is set to an “off” status, the second client device will output a new message notification in the first format. Or the second client device will output a new message notification in a second format no matter what setting of the client application or the client device is.

In an example, two users Linda and Amy set up a chat. The new message notification setting of the client application of Amy is set to an “off” status. The new message notification setting of the client application of Linda is set to an “on” status. Linda sends a message “@ Where are you?” to Amy. After receiving the message, the client device of Amy founds that the message includes the tag “@”. Though the new message notification setting of the client application of Amy is set to an “off” status, the client device of Amy will still output a new message notification, for example, in the first format, that is, output a new message notification as when the new message notification setting of the client application is set to an “on” status, such as playing a sound. Soon afterwards, Any sends a response message “@ At home” to Linda. After receiving the message, the client device of Linda founds that the message includes the tag “@”. The client device of Linda will output a new message notification in a second format for the new message notification setting of the client application of Amy is set to an “on” status. Usually, the second format is different from the first format. For example in the second format the client device will play a sound as well as vibrate for a few seconds.

It can be seen that, by the method of transmitting a message discussed above, when the message includes the tag, the receiver of the message will always be notified no matter what setting of the client application or the client device is.

A similar circumstance appears in a group chat. Usually, in a group chat, the client device will output a new message notification whenever a new message is received no matter whether the user is interested in the content of the message or not. While when the user switches the new message notification setting of the client application or the client device to an “off” status to avoid disturbance from frequent new message notifications, he/she cannot notice the message, thus he/she cannot response in time if someone has sent he/her a message with something really urgent or important.

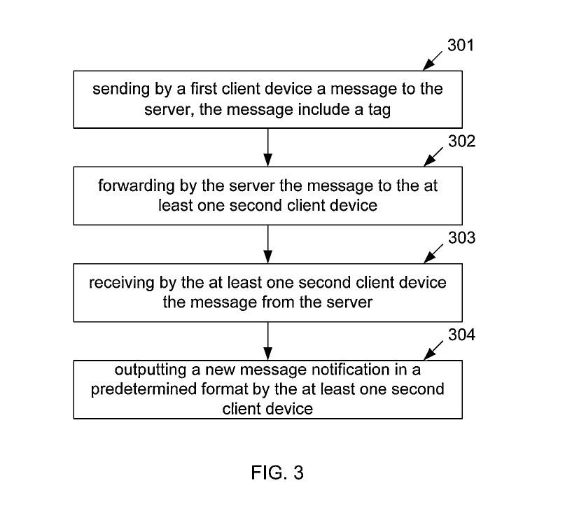

Referring now to FIG. 3, a block diagram of transmitting a message in group chat in accordance with an example of the present disclosure is depicted. The message can be but not limited to an instant message. The procedure of FIG. 3 may be implemented by various types of hardware, software, device, computer, computer system, equipment, component, program, application, code, storage medium, or propagated signal.

The method shown in FIG. 3 involves sending by a first client device a message to the server 160, the message include a tag (block 301), forwarding by the server 160 the message to the at least one second client device (block 302), receiving by the at least one second client device the message from the server 160 (block 303) and outputting a new message notification in a predetermined format by the at least one second client device (block 304).

Detailed processes of FIG. 3 are similar to those of FIG. 2.

In block 301, the message sent by the first client device may include a tag indicating that the message is of a higher priority than other messages, and the receiver of message should be notified of the arrival of the message in a predetermined format.

The tag can be a self-defined character or a character string, such as &, * or #. In at least one preferred example, the tag can be @.

In block 302, the server 160 forwards the message received from the first client device to the second client device as a regular message without the tag.

In block 303, the second client device receives the message from the server 160.

In block 304, the second client device determines whether the message includes the tag by searching the content of the message for the tag, when the message includes the tag, it means that the message is of a higher priority, and the second client device should output a new message notification in a predetermined format. Then the second client device will output a new message notification in a predetermined format. Especially, when new message notification setting of the client application or the client device is set to an “off” status, the second client device will output a new message notification in the first format. Or the second client device will output a new message notification in a second format no matter what setting of the client application or the client device is.

For example, four users Linda, Amy, Marry and Sue set up a group and start a group chat. The new message notification setting of the client application of Amy and Sue is set to an “off” status. The new message notification setting of the client application of Linda and Marry is set to an “on” status. In this group chat, Linda wants to ask all the others where they are. In this case, Linda can send a message like “@ Where are you?” to the server 160. The server 160 then forwards the message to Amy, Marry and Sue. After receiving the message, the client devices of Amy and Sue found that the message includes the tag “@”. Though the new message notification setting of the client application of Any and Sue is set to an “off” status, the client devices of Amy and Sue will still output a new message notification to Amy and Sue, for example, in the first format, that is, as when the new message notification setting of the client application is set to an “on” status, such as playing a sound. While the client device of Marry founds that the message includes the tag “@”. The client device of Marry will notify Marry, for example, in the second format for the new message notification setting of the client application of Marry is set to an “on” status. For example in the second format the client device will play a sound as well as vibrate for a few seconds.

It can be seen that, by the method of transmitting a message in a group chat discussed above, when the message includes the tag, the receiver(s) of the message will always be notified no matter what setting of the client application or client device is.

In some cases, when discuss a specific topic in a group chat, a user may want to talk with only one or only a part of the members of the group. That is, the user may want one or a part of the members of the group to pay more attention as well as respond quickly to the message he/she sent.

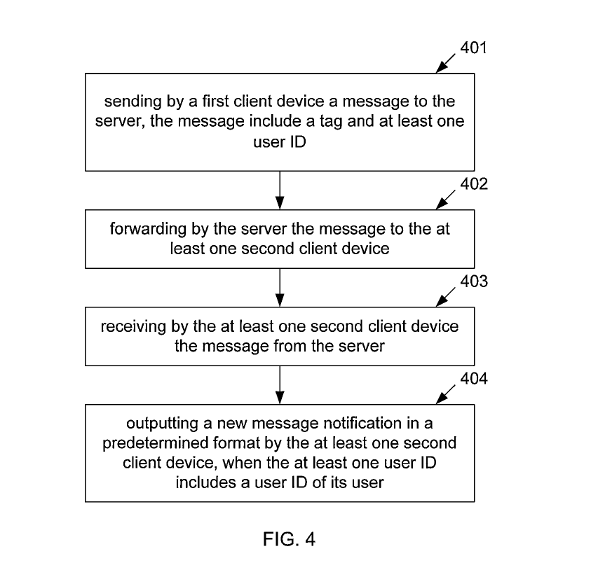

Referring now to FIG. 4, a block diagram of transmitting a message in group chat in accordance with another example of the present disclosure is depicted. The message can be but not limited to an instant message. The procedure of FIG. 4 may be implemented by various types of hardware, software, device, computer, computer system, equipment, component, program, application, code, storage medium, or propagated signal.

The method shown in FIG. 4 involves sending by a first client device a message to the server 160, the message include a tag and at least one user ID (block 401), forwarding by the server 160 the message to the at least one second client device (block 402), receiving by the at least one second client device the message from the server 160 (block 403) and outputting a new message notification in a predetermined format by the at least one second client device when the at least one user ID includes a user ID of its user (block 404).

In block 401, the message sent by the first client device may include a tag indicating that the message is of a higher priority than other messages, and the receiver of the message should be notified of the arrival of the message. Further, when the message is said to only a part of the members of the group, at least one user ID can be input in the message, for example, following the tag. The user ID can be a unique identification of the user in the group, such as a nick name including a nick group name used only in the group set by the user or the account number (such as a IM account number, an email account, and a phone number) of the user. In many applications, such as WeChat (WeiXin) and QQ, a user can give a remark name to one of his buddies to remind the user who this buddy is. Therefore, in at least one preferred example, the user ID can be the remark name of the user.

As described above, the tag can be any kind of self-defined character or character string, such as &, * or #. In at least one preferred example, the tag can be @.

In one implementation, a user can input messages through the input device of the client device, such as keyboards. When the user input the tag, such as @, the client device will prompt a list of user IDs of the members of the group. The user then can make a selection to choose at least one of the user IDs. As discussed above, the user ID can be one of the following: the remark name, the nick name, the account number, and etc. After receiving the selection of the user, the user IDs will be automatically added in the content of the message, for example, subsequent to the tag. And then the user goes on inputting the content of the message. After the user completes inputting the message, the client device will send the message to the server 160.

If the message includes more than one user ID, the more than one user ID should be separated by a separative sign, such as a space or the tag or another self-defined character or character string.

In block 402, the server 160 forwards the message with a tag received from the first client device to the second client device as a regular message without the tag.

In block 403, the at least one second client device receives the message from the server 160 separately.

In block 404, the at least one second client device determines separately whether the message includes the tag by searching the content of the message for the tag; when the message includes the tag, each second client device further determines whether the message includes the user ID of its user, wherein the user ID associates with the account of the user using the second client. When the message includes the user ID of its user, it means that the second client device should output a new message notification in a predetermined format.

Alternatively, in block 404, the at least one second client device determines separately whether the message includes the tag by searching the content of the message for the tag; when the message includes the tag, each second client device further determines whether the message includes a user ID; when the message includes no user ID, it means that the second client device should output a new message notification; and when the message includes a user ID, each second client device further determines whether the user ID of its user is included in the message, and when the user ID of its user is included in the message, it means that the second client device should output a new message notification. Then the second client device will output a new message notification in a predetermined format.

For example, four users Linda, Amy, Marry and Sue set up a group and start a group chat. The new message notification setting of the client application of Amy and Sue is set to an “off” status. The new message notification setting of the client application of Linda and Marry is set to an “on” status. In this group chat, Linda wants to ask Sue where she is. In this case, Linda can first input the tag “@”, the client device of Linda then prompts a list of user IDs of Amy, Marry and Sue to Linda. Now Linda can select the user ID of Sue and input “Where are you?” to complete the message. Now the message will look like “@Sue Where are you?”. The message will be sent by the client device of Linda to the server 160. The server 160 then forwards the message to Amy, Marry and Sue. After receiving the message, the client device of Amy founds that the message includes the tag “@” but not includes the user ID “Amy”. The client device of Amy will not output the new message notification for the new message notification setting of the client application of An is set to an “off” status. The client device of Marry founds that the message includes the tag “@” but not includes the user ID “Marry”. The client device of Marry will output the new message notification, for example, in the first format for the new message notification setting of the client application of Marry is set to an “on” status. The client device of Sue founds that the message includes the tag “@” as well as the user ID “Sue”. Though the new message notification setting of the client application of Sue is set to an “off” status, the client device of Sue will still output the new message notification, for example, in the first format.

It can be seen that, by the method of transmitting a message in a group chat discussed above, when the message includes the tag with at least one user ID followed, the receiver(s) of the message whose user ID is pointed out in the message will always be notified no matter what setting of the client application is.

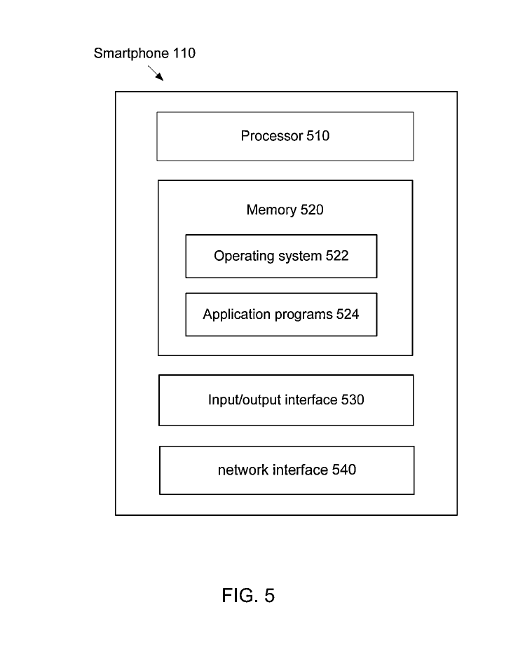

FIG. 5 is a schematic diagram illustrating a client device for transmitting a message in accordance with an example of the present disclosure. Hereinafter, the smartphone 110 is taken as an exemplary client device. As shown in FIG. 5, the smartphone 110 includes at least one CPU or at least one processor 510, a memory 520, an input/output interface 530 and a network interface 540. Various modifications, additions or deletions may be made to the smartphone 110 illustrated in FIG. 5 within the scope of the present disclosure.

Processor 510 performs computation and control functions of the smartphone 110. Processor 510 may include a single integrated circuit, such as a microprocessor, or may include any suitable number of integrated circuit devices and/or circuit boards working in cooperation to accomplish the functions of a processor or a CPU. The processor 510 is configured to execute one or more software programs contained in the memory 520.

The memory 520 may store data and programs such as an operating system 522 and one or more application programs 524.

The input/output interface 530 enables wired or wireless connection to various internal or external input/output devices for receiving information from and transmitting information to these devices. In at least one preferred example, the input device may include keyboards, mice, touch screen, microphone and etc. The output device may include a display device, a loudspeaker, earphone and etc.

The network interface 540 enables wired or wireless connection to the internet 130 through the link 170 for receiving information from and transmitting information to the server 160.

As a sender of the message, the memory 520 includes instructions for receiving a message input by the user through an input device and the input/output interface 530, and sending the message to the server 160 through the network interface 540, link 170 and internet 130.

The memory 520 further includes instructions for receiving a tag input by the user through an input device and the input/output interface 530, displaying a list of the user IDs of the member of the group to the user through the input/output interface 530 and a output device, such as a displaying device, receiving the selection of the user through an input device and the input/output interface 530 and adding the user ID selected by the user in the message.

As a receiver of the message, the memory 520 includes instructions for receiving a message from the server 160 through the network interface 540, link 170 and internet 130, determining whether the message includes a tag, and outputting a new message notification in a predetermined format through the input/output interface 530 and an output device, when a tag is included in the message.

The memory 520 further includes instructions for determining whether the message includes the user ID of its user, when a tag is included in the message, and outputting a new message notification in a predetermined format through the input/output interface 530 and an output device, when the user ID of its user is included in the message.

Alternatively, the memory 520 further includes instructions for determining whether the message includes a user ID, when the message includes no user ID, outputting a new message notification in a predetermined format through the input/output interface 530 and an output device; and when the message includes a user ID, further determining whether the user ID of its user is included in the message when a tag is included in the message, and outputting a new message notification in a predetermined format through the input/output interface 530 and an output device, when the user ID of its user is included in the message.

Detailed functions of the smartphone 110 have been described above with reference to the method example and will not be repeated herein.

As will be appreciated by one skilled in the art, aspects of the disclosed network computer system 100 disclosed herein may be embodied as a system, method or computer program product. Accordingly, aspects of the network computer system may take the form of an hardware embodiment, an software embodiment or an embodiment combining software and hardware aspects that may all generally be referred to herein as a “circuit”, “module” or “system”. Furthermore, aspects of the network computer system may take the form of a computer program product embodied in one or more computer readable medium(s) having computer readable program code embodied thereon.

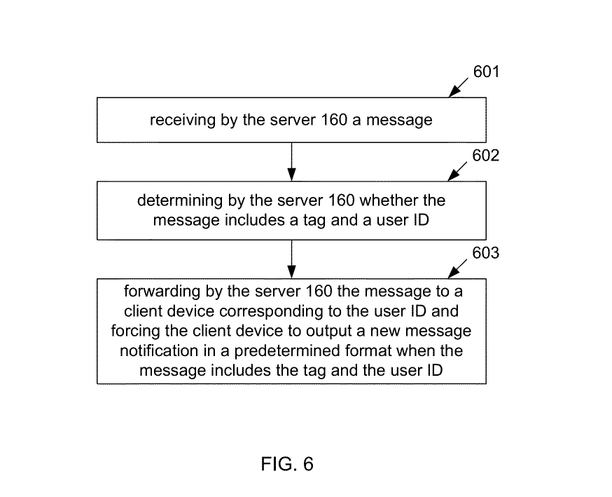

Referring now to FIG. 6, a block diagram of forwarding a message by a server in accordance with another example of the present disclosure is depicted. The message can be but not limited to an instant message. The procedure of FIG. 6 may be implemented by various types of hardware, software, device, computer, computer system, equipment, component, program, application, code, storage medium, or propagated signal.

The method shown in FIG. 6 involves receiving by the server 160 a message (block 601); determining by the server 160 whether the message includes a tag and a user ID (block 602); and forwarding by the server 160 the message to a client device corresponding to the user ID and forcing the client device to output a new message notification in a predetermined format when the message includes the tag and the user ID (block 603).

In block 602, the tag indicates that the message is of a higher priority than other messages, and the message should be forwarded to the receiver identified by the user ID in a different way to force the receiver output a new message notification in a predetermined format.

In block 603, the predetermined format can be the first format when the new message notification setting of the client application or the client device is set to an “off” status. The predetermined format can also be the second format when the new message notification setting of the client application or the client device is set to an “on” status.

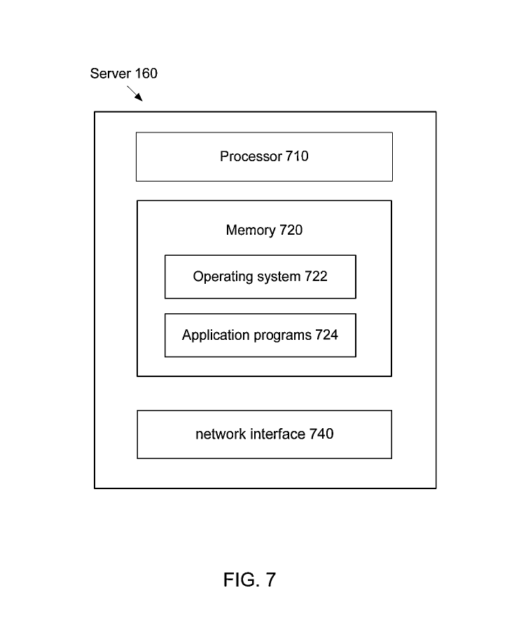

FIG. 7 is a schematic diagram illustrating a device for forwarding a message in accordance with an example of the present disclosure. Hereinafter, the server 160 is taken as an exemplary device for forwarding a message. As shown in FIG. 7, the server 160 includes at least one CPU or at least one processor 710, a memory 720, and a network interface 740. Various modifications, additions or deletions may be made to the server 160 illustrated in FIG. 7 within the scope of the present disclosure.

Processor 710 performs computation and control functions of the server 160. Processor 710 may include a single integrated circuit, such as a microprocessor, or may include any suitable number of integrated circuit devices and/or circuit boards working in cooperation to accomplish the functions of a processor or a CPU. The processor 710 is configured to execute one or more software programs contained in the memory 720.

The memory 720 may store data and programs such as an operating system 722 and one or more application programs 724.

The network interface 740 enables wired or wireless connection to the internet 130 through the link 170 for receiving information from and transmitting information to other devices.

The memory 620 stores at least one program which is configured for execution by the at least one processor. The at least one program including instructions to: receive a message; determine whether the message includes a tag and a user ID; forward the message to a client device corresponding to the user ID and force the client device to output a new message notification in a predetermined format when the message includes the tag and the user ID.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A computer-implemented method for transmitting a message, comprising:
sending, by a first client device, a message to a server, wherein the message includes a tag;
forwarding, by the server, the message to at least one second client device;
receiving, by each of the at least one second client device, the message from the server; and
outputting, by each of the at least one second client device, a new message notification in a predetermined format.

2. The computer-implemented method of claim 1, wherein the tag is a self-defined character or a character string.

3. The computer-implemented method of claim 1, wherein the message further comprises at least one user ID;
the method further comprising: determining, by each of the at least one second client device, whether a user ID of its user is included in the message, and
performing the operation of outputting the new message notification in the predetermined format when the user ID of its user is included in the message.

4. The computer-implemented method of claim 1, wherein outputting a new message notification in a predetermined format comprises:
when new message notification setting of the client device or client application is set to an “off” status, outputting a new message notification in a first format.

5. The computer-implemented method of claim 1, wherein outputting a new message notification in a predetermined format comprises:
when new message notification setting of the client device or client application is set to an “on” status, outputting a new message notification in a second format.

6. A computer-implemented method for transmitting a message, comprising:
receiving a message from a server;
determining whether the message includes a tag; and
outputting a new message notification in a predetermined format when the message includes the tag.

7. The computer-implemented method of claim 6, further comprising:
determining whether a user ID of its user is included in the message; and
performing the operation of outputting the new message notification in the predetermined format when the user ID of its user is included in the message.

8. The computer-implemented method of claim 6, further comprising:
determining whether the message includes a user ID and determining whether the user ID of its user is included in the message when the message includes a user ID; and
performing the operation of outputting the new message notification in the predetermined format when the message includes no user ID or when the message includes the user ID of its user.

9. The computer-implemented method of claim 6, wherein outputting a new message notification in a predetermined format comprises:
when new message notification setting of the client device or the client application is set to an “off” status, outputting a new message notification in a first format.

10. The computer-implemented method of claim 6, wherein outputting a new message notification in a predetermined format comprises:
when new message notification setting of the client device or the client application is set to an “on” status, outputting a new message notification in a second format.

11. A device for transmitting a message, comprising:
memory;
at least one processor; and
at least one program stored in the memory and configured for execution by the at least one processor, the at least one program including instructions to:
receive a message from a server;
determine whether the message includes a tag; and
output a new message notification in a predetermined format when the message includes the tag.

12. The device of claim 11, wherein the at least one program further including instructions to:
determine whether a user ID of its user is included in the message; and
output a new message notification in a predetermined format when the user ID of its user is included.

13. A computer-implemented method for forwarding a message, comprising:
receiving a message;
determining whether the message includes a tag and a user ID; and
forwarding the message to a client device corresponding to the user ID and forcing the client device to output a new message notification in a predetermined format when the message includes the tag and the user ID.

14. The computer-implemented method of claim 13, wherein forcing the client device to output a new message notification in a predetermined format comprises:
when new message notification setting of the client device or the client application is set to an “off” status, forcing the client device to output a new message notification in a first format.

15. The computer-implemented method of claim 13, wherein outputting a new message notification in a predetermined format comprises:
when new message notification setting of the client device or the client application is set to an “on” status, forcing the client device to output a new message notification in a second format.
